(19) United States
(12) Patent Application Publication
(10) Pub. No.: US 2015/0341478 A1
(43) Pub. Date: Nov. 26, 2015

(54) SEAMLESS FRONT COVER FOR AN ELECTRONIC DEVICE

(71) Applicant: NOKIA TECHNOLOGIES OY, Espoo (FI)

(72) Inventors: Mason Archer Bonar, Houston, TX (US); Jian Wang, Beijing (CN)

(73) Assignee: Nokia Technologies Oy, Espoo (FI)

(21) Appl. No.: 14/758,885

(22) PCT Filed: Jan. 7, 2013
(86) PCT No.: PCT/CN2013/070177

§ 371 Date: Jul. 1, 2015

(51) Int. Cl. H04M 1/11

(52) U.S. Cl. CPC H04M 1/11

(57) ABSTRACT

In accordance with an example embodiment of the present invention, an apparatus comprises a flexible cover formed from a transparent flexible material and comprising a front surface, side surfaces, and a rear surface. The front surface comprises a keypad region and a display region, and the side surfaces encompass the periphery of the front surface. The rear surface comprises a coating of colored material within the keypad and display regions, and the display region comprises a transparent display portion. The apparatus also comprises a frame over which the cover is integrally attached to define a seamless unitary cover frame configured to serve as a front cover of an electronic device.

### TECHNICAL FIELD

The present application relates generally to housing covers for electronic devices.

### BACKGROUND

Personal mobile devices are increasingly popular with consumers. A wide variety of mobile devices are available on the market, with smartphones currently being among the most widely adopted mobile devices. Smartphones and other mobile electronic devices include an input device, such as a keypad, which allows a user to manually enter information. Keypads are electro-mechanical devices made up of several components, requiring gaskets and seals to prevent contamination of keypad and internal components of the electronic device to which the keypad is mounted.

### SUMMARY

Various aspects of examples of the invention are set out in the claims.

According to a first aspect of the present invention, an apparatus comprises a contiguous flexible cover formed from a transparent flexible material and comprising a front surface, side surfaces encompassing the periphery of the front surface, and a rear surface comprising a keypad region, a display region, and a coating of colored material within the keypad and display regions. The display region comprises a transparent portion. A frame is integrally attached to the cover to define a seamless unitary cover frame configured to serve as a front cover of an electronic device. The transparent portion of the display region is configured to align with the display of the electronic device.

According to a second aspect of the present invention, an apparatus comprises a contiguous flexible cover formed from a transparent flexible material and comprising a front surface, peripheral side surfaces, and a rear surface comprising a keypad region and a display region. The display region comprises a transparent portion. A frame is integrally attached to the cover to define a seamless unitary cover frame configured to serve as a front cover of an electronic device. The transparent portion of the display region is configured to align with the display of the electronic device.

According to a third aspect of the present invention, a method comprises forming a discrete piece of transparent flexible material in the shape of a front cover of an electronic device so that the cover is shapeable to comprise a front surface, side surfaces encompassing the periphery of the front surface, and a rear surface comprising a keypad region and a display region. The method also comprises applying colored material at locations on the rear surface, with a display portion of the display region remaining transparent. The method further comprises co-molding the colored discrete piece of material and a discrete frame to produce a seamless unitary cover frame configured to serve as the front cover of the electronic device.

According to a fourth aspect of the present invention, an apparatus comprises a contiguous flexible cover formed from a transparent flexible material and comprising a front surface, peripheral side surfaces, and a rear surface comprising a keypad region and a display region. The display region comprises a transparent portion. A frame is integrally attached to the cover to define a seamless unitary cover frame configured to serve as a front cover of an electronic device. The transparent portion of the display region is configured to align with the display of the electronic device.

According to a fifth aspect of the present invention, an apparatus comprises means for forming a discrete piece of transparent flexible material in the shape of a front cover of an electronic device so that the cover is shapeable to comprise a front surface, side surfaces encompassing the periphery of the front surface, and a rear surface comprising a keypad region and a display region. The apparatus also comprises means for applying colored material at locations on the rear surface. A display portion of the display region remains transparent. The apparatus further comprises means for co-molding the colored discrete piece of material and a discrete frame to produce a seamless unitary cover frame configured to serve as the front cover of the electronic device.

### BRIEF DESCRIPTION OF THE DRAWINGS

For a more complete understanding of example embodiments of the present invention, reference is now made to the following descriptions taken in connection with the accompanying drawings in which:

FIG. 1 illustrates a conventional front cover of an electronic device, such as a mobile phone;

FIG. 2 illustrates a seamless front cover frame configured to serve as a front cover of an electronic device in accordance with example embodiments of the present invention;

FIG. 3 illustrates an example frame of a seamless front cover frame configured to serve as a front cover of an electronic device in accordance with example embodiments of the present invention;

FIG. 4 illustrates an example frame and flexible cover of a seamless front cover frame configured to serve as a front cover of an electronic device in accordance with example embodiments of the present invention;

FIG. 5 illustrates a seamless front cover frame configured to serve as a front cover of an electronic device in accordance with other example embodiments of the present invention;

FIG. 6 illustrates an assembled electronic device which includes a seamless front cover frame serving as a front cover of the electronic device in accordance with example embodiments of the present invention;

FIG. 7 is a flow chart illustrating a method of constructing a seamless front cover frame configured to serve as a front cover of an electronic device in accordance with example embodiments of the present invention;

FIG. 8 is a flow chart illustrating a method of constructing a seamless front cover frame configured to serve as a front cover of an electronic device in accordance with example embodiments of the present invention;

FIG. 9 is a flow chart illustrating a method of constructing a seamless front cover frame configured to serve as a front cover of an electronic device and a light guide in accordance with example embodiments of the present invention;

FIG. 10 illustrates an example press apparatus for forming a discrete piece of transparent flexible material into the shape of a cover for an electronic device in accordance with example embodiments of the present invention;

FIG. 11 illustrates an example printing station for applying colored material to a rear surface of the discrete piece of transparent flexible material shown in FIG. 10 in accordance with example embodiments of the present invention; and

FIG. 12 illustrates an example mold for co-molding the colored discrete piece of transparent flexible material shown in FIG. 11 and a rigid plastic frame to form a seamless unitary cover frame configured to serve as a front cover of an electronic device in accordance with example embodiments of the present invention.

### DETAILED DESCRIPTION OF THE DRAWINGS

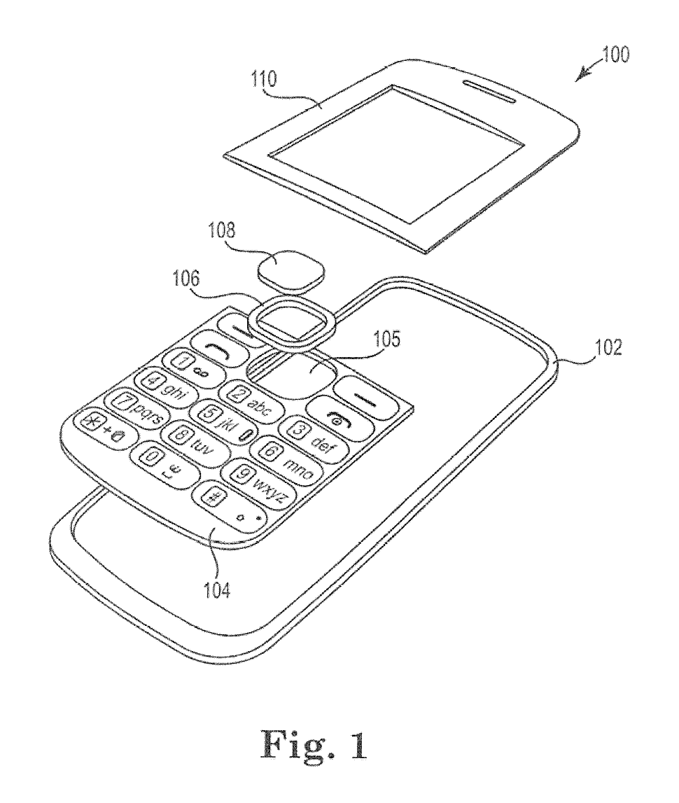

Example embodiments of the present invention and their potential advantages are understood by referring to FIGS. 1 through 12 of the drawings.

The present disclosure generally relates to housings for an electronic device. In the following description, an example electronic device is shown as a cellular phone, although it will be appreciated that the concepts described herein may be applied to any similar device equipped with a keypad or similar input device (e.g., tablet computer or other PDA, navigation device, media player, gaming console, etc.). Example embodiments of the disclosure are directed to a seamless front cover frame configured to serve as a front cover of an electronic device. Various example embodiments of the disclosure are directed to a transparent flexible material and integral frame that define a seamless unitary cover frame configured to serve as a front cover of an electronic device.

FIG. 1 illustrates components of a conventional front cover of an electronic device, such as a mobile phone. The example front cover 100 includes five separate components, each of which must be accurately positioned and installed in the proper order to the chassis of an electronic device. The front cover 100 shown in FIG. 1 includes a cover piece 102 which is dimensioned to engage the periphery of the electronic device's chassis during assembly. The lower portion of the front cover 100 includes a keypad 104, a navigation ring 106, and a center key 108. The upper portion of the front cover 100 includes a windows lens 110, which includes a central void to accommodate a display of the electronic device.

Assembling the multi-piece front cover 100 typically involves accurately positioning each of the components on the electronic device's chassis, and then securing each component in their proper assembly order using the appropriate fasteners. One example assembly approach involves positioning the keypad 104 within the lower portion of the front cover 100, inserting the navigation ring 106 into the cut-out 105, and installing the center key 108 within the navigation ring 106. The window lens 110 must be accurately positioned within the upper portion of the front cover 100. The four components shown in FIG. 1 positioned within the upper and lower portions of the front cover 100 are then secured in place by proper installation of the cover piece 102, which is securely mounted to the periphery of the electronic device chassis. It can be appreciated that the conventional front cover 100 illustrated in FIG. 1 represents a relatively complex cover configuration due to its multiplicity of parts and assembly steps. Although not shown in FIG. 1, the multiple-piece front cover assembly shown in FIG. 1 requires a number of seals and gaskets to ensure proper protection against environmental contaminants, such as dust, dirt, liquids, and finger debris resulting from user manipulation of the electronic device.

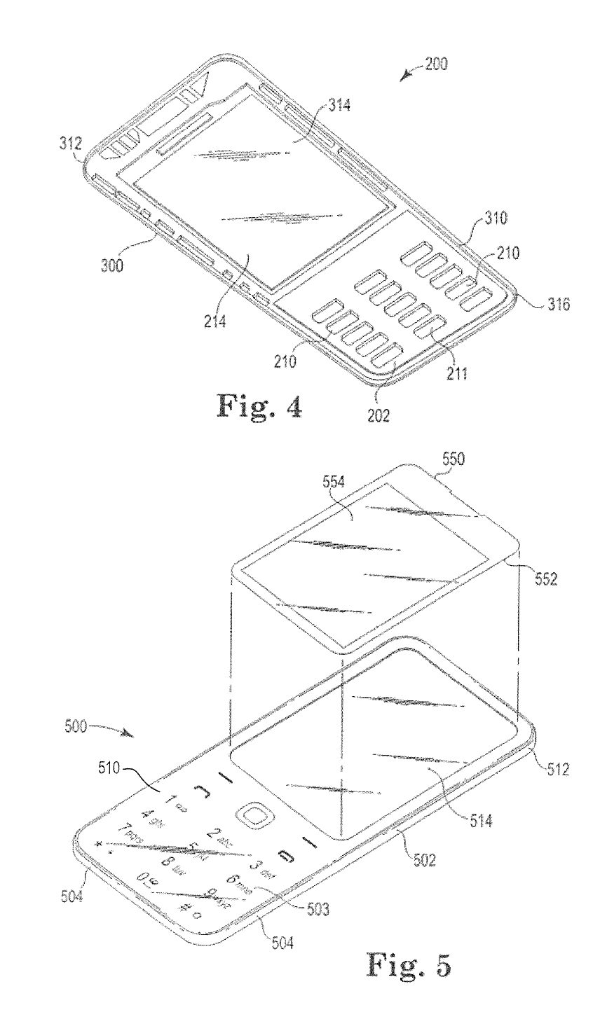

FIG. 2 illustrates a seamless front cover frame configured to serve as a front cover of an electronic device in accordance with example embodiments of the present invention. According to various example embodiments, the front cover frame 200 shown in FIG. 2 comprises a contiguous flexible cover 202 formed from a transparent flexible material. The flexible cover 202 comprises a front surface 203, peripheral side surfaces 204, and a rear surface 206. The rear surface 206 comprises a keypad region 210 and a display region 212, which are viewable through the front surface 203 due to the transparency of the flexible cover material. The side surfaces 204 encompass the periphery of the front surface 203. The peripheral side surfaces 204 are contiguous extensions of the flexible material that covers the front surface 203 of the front cover frame 200. The rear surface 206 comprises a coating of colored material within the keypad region 210 and the display region 212 (see, e.g., rear view of frame 200 in FIG. 4). In some example embodiments, the coating of colored material includes one or more layers of colored ink, paint, or pigment containing material. A portion 214 of the display region 212 is devoid of colored material (i.e., an absence of the colored material). Because the material forming the flexible cover 202 is transparent, any portion of the rear surface 206 which is devoid of colored material, such as the display portion 214, remains transparent. The portion 214 of the display region 212 represents a transparent portion of the flexible cover 202 dimensioned to cover and allow viewing of a display of an electronic device to be protected by the front cover frame 200. For example, the transparent portion 214 of the display region 212 is configured to align and be substantially coextensive with the display of the electronic device (e.g., mobile phone).

In some example embodiments, a region of the front surface 203 coextensive with the transparent portion 214 of the display region 212 is treated to increase the durability of this portion of the front cover frame 200. For example, a UV-curable acrylate-based hard coat resin can be applied to the region of the front surface 203 coextensive with the transparent portion 214 as a protective coating which also provides good optical clarity. In other example embodiments, a rigid transparent plastic window with good optical clarity and scratch resistance is co-molded with the flexible cover 202 so that the plastic window insert is positioned on the front surface 203 and covers the transparent portion 214 of the display region 212, in which case the transparent portion 214 may be thinner relative to other portions of the flexible cover (e.g., 50% thinner). In some example embodiments, a rigid transparent plastic window insert with good optical clarity and scratch resistance is co-molded with the flexible cover 202 so that the plastic window insert substitutes for the transparent portion 214 of the display region 212. In further example embodiments, a window lens assembly is mounted to the front cover frame 200 over the display region 214, as will be further described hereinbelow.

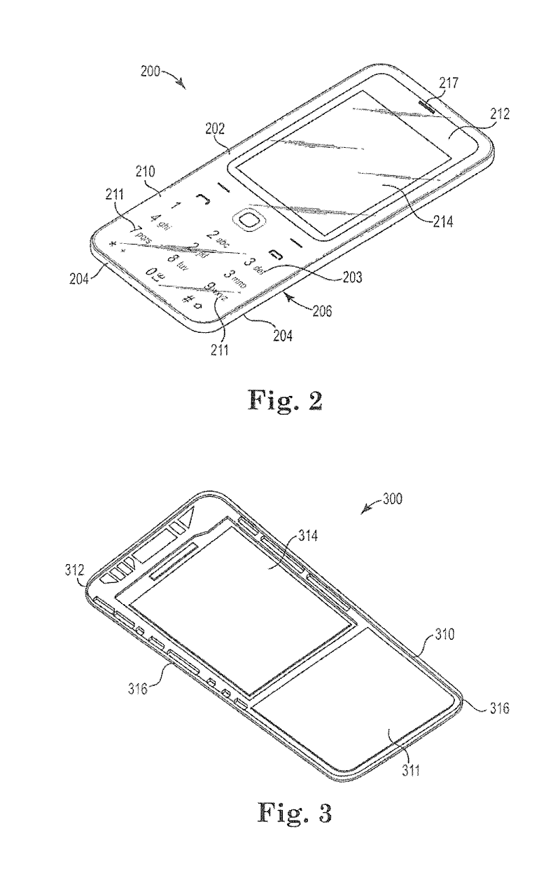

FIGS. 3 and 4 illustrate a frame 300 over which the flexible cover 202 shown in FIG. 2 is integrally attached to define a seamless unitary cover frame configured to serve as a front cover of the electronic device in accordance with example embodiments. FIG. 3 shows a rear view of the frame 300 without the flexible cover 202 attached to the front surface of the frame 300. FIG. 4 shows a rear view of the frame 300 with the flexible cover 202 attached to the front surface of the frame 300. In the example embodiment shown in FIG. 3, the frame 300 includes a keypad region 310, a display region 312, and a cut-out portion 314 of the display region 312. The cut-out portion 314 of the display region 312 is dimensioned to allow viewing of a display of an electronic device to be protected by the front cover frame 200. For example, the cut-out portion 314 of the display region 312 is configured to be substantially coextensive with the display of the electronic device (e.g., mobile phone). The frame 300 also includes a number of fastener features 316 which are configured to engage with fastening features of the electronic device housing onto which the front cover frame 200 is attached.

The keypad region 310 of the frame 300 comprises a keypad cut-out 311 which is dimensioned to allow a standard keypad to be installed underneath the keypad region 211 of the front flexible cover 202. The ductility and tactile characteristics of the flexible cover material is designed to enhance user interaction and aesthetics, since the keys of a standard keypad installed underneath the keypad region 211 are covered by the flexible cover 202 and not directly felt by the user. Use of a standard keypad in an electronic device that incorporates a flexible front cover frame 200 according to various example embodiments reduces the cost and complexity of the keypad and associated components (e.g., seals, gaskets, etc.). It can be readily appreciated that the example seamless front cover frame 200 illustrated in FIGS. 2-4 represents a unitary front cover apparatus for an electronic device which offers a significant reduction in components, greater simplicity in terms of environmental sealing strategy, less visual parts and internal components, and a different and enhanced tactile experience and feeling with regard to keyboard interaction by a user.

According to various example embodiments, the transparent flexible material used to fabricate the flexible cover 202 comprises a thermoplastic elastomeric material. In some example embodiments, the transparent flexible material comprises a thermoplastic polyurethane (TPU). According to other example embodiments, the frame is formed from a rigid plastic material. In various example embodiments, the frame is formed from polycarbonate and acrylonitrile butadiene styrene (PC-ABS). In accordance with an example embodiment, the transparent flexible material comprises TPU and the frame is formed from PC-ABS. In some example embodiments, the frame and the flexible cover define a co-molded unitary structure. In further example embodiments, the transparent portion 214 of the display region 212 comprises a coating of UV-protective material to reduce clouding and/or coloration of the transparent portion 214.

As is further shown in FIG. 2, the keyboard region 210 comprises a multiplicity of key regions 211 configured to conform to a predetermined keypad layout. In some example embodiments, the key regions 211 are configured to conform to an ITU (International Telecommunication Union) keypad layout. In other example embodiments, the key regions 211 are configured to conform to a QWERTY keypad layout. In the example embodiment shown in FIG. 2, each of the key regions 211 is associated with a single or multi-mode key of an underlying keypad for entering numbers, letters, and other symbols, for example. The flexible cover 202 includes one or more cut-outs, such as an ear hole 217 and a camera hole (not shown), which are formed using a punch press.

FIG. 4 illustrates an example frame 300 and flexible cover 202 of a seamless front cover frame 200 configured to serve as a front cover of an electronic device in accordance with example embodiments of the present invention. In FIG. 4, the rear surface of the keypad region 210 of the flexible cover 202 can be seen. As was previously discussed, the rear surface of the flexible cover 202 comprises a coating of colored material within at least the keypad region 210 and a portion of the display region 212 other than within the portion 214 of the display region 212 which is designed to be transparent. Prior to assembly, and according to some example embodiments, the rear surface of the flexible cover 202 is coated with one or more colored materials to create a desired color design to enhance the aesthetics of the front cover frame 200. Because the front surface of the flexible cover 202 remains transparent, colors, graphics, and designs are applied to the rear surface of the flexible cover 202 in reverse order, since the layers of applied colored materials are viewed through the transparent front surface of the flexible cover 202.

The rear surface of the flexible cover 202 is also coated with colored material to create various indicia (e.g., alphanumeric characters and other symbols) within the key region 211, the display region 212 (e.g., the border region surrounding the transparent portion 214), and other portions of the cover's rear surface. In some embodiments, the indicia are formed using high contrast colored ink to enhance visibility of the indicia. In other embodiments, the indicia are formed as transparent portions of the rear surface of the flexible cover 202. Masking, for example, can be used to prevent application of the various colored materials to portions of the cover's rear surface which are intended to remain transparent. In some example embodiments, the masked portions include the various characters within the key regions 211 of the keypad region 210 and the large transparent portion 214 of the display region 212. The keyed regions 211, for example, can be illuminated by a lighted keypad or light guide which is installed underneath the front cover frame 200. The colored materials, graphics, and designs applied to the flexible cover 202 are protected from the environment and users' fingers since these features are created on the rear surface of the flexible cover 202 and not exposed to the environment.

FIG. 5 illustrates a seamless front cover frame 500 configured to serve as a front cover of an electronic device in accordance with example embodiments of the present invention. The front cover frame 500 shown in FIG. 5 comprises a flexible cover 502 formed from a transparent flexible material which is integrally attached to a rigid frame to define a seamless unitary cover frame structure configured to serve as a front cover of the electronic device. The flexible cover 502 comprises a front surface 503 with a keypad region 510 and a display region 512 viewable through the front surface 503. The flexible cover 502 further includes side surfaces 504 which encompass the periphery of the front surface 503. The peripheral side surfaces 504 are contiguous extensions of the flexible material that covers the front surface 503 of the front cover frame 500. The flexible cover 502 also includes a rear surface (not shown in FIG. 5) comprising a coating of colored material within the keypad region 510 and display region 512.

According to some example embodiments, the display region 512 includes a portion 514 which is not coated with colored material and, therefore, remains transparent. A window lens 550 is shown in FIG. 5, which comprises a frame 552 and a lens 554. In some example embodiments, the frame 552 is formed from rigid plastic, and the lens 554 is plastic or glass. The window lens 550 is configured to be mounted on the front cover frame 500 and cover the portion 514 of the display region 512. In some example embodiments, the window lens 550 serves to protect the transparent portion 514 of the display region 512, which may be thinner (e.g., 50% thinner) than other portions of the flexible cover 502. The window lens 550 adds durability to the transparent portion 514 of the display region 512 and serves to aesthetically enhance the front cover frame 500. According to some example embodiments, an adhesive is applied between the frame 552 of the window lens 550 and the periphery of the display region 512 proximate the transparent portion 514 to ensure good attachment of the window lens 550 to the flexible cover 502. In other example embodiments, mechanical fasteners can be used to secure the window lens 550 to the flexible cover 502. According to other example embodiments, the window lens 550 is co-molded with the flexible cover 502 so that the lens 554 covers the transparent portion 514 of the display region 512, in which case the transparent portion 514 may be thinner (e.g., 50% thinner) relative to other portions of the flexible cover 502. In some example embodiments, the window lens 550 is mounted to the front cover frame 500 over the display region 514 which is devoid of the transparent material.

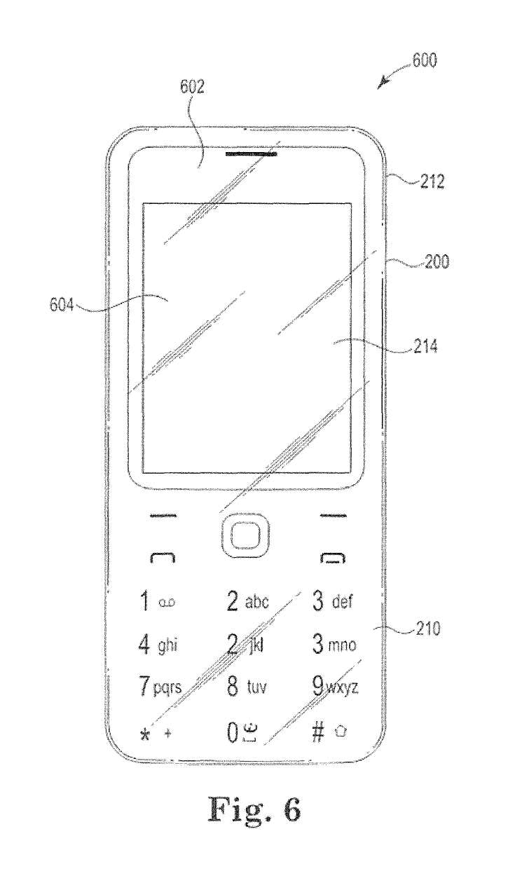

FIG. 6 illustrates a fully assembled electronic device 600 which includes a seamless front cover frame 200 serving as a front cover of the electronic device 600 in accordance with example embodiments of the present invention. According to some example embodiments, the front cover frame 200 comprises a display region 212 with a transparent portion 214 dimensioned to allow viewing of the device's display 604 (e.g., the transparent portion 214 is configured to be substantially coextensive with the device's display 604). In some example embodiments, the transparent portion 214 of the display region 212 is larger than the active area of the device's display 604, allowing for all or a portion of a window frame 602 of the display 604 to be viewable. In other example embodiments, the portion 214 of the display region 212 is a void instead of a transparent section of the display region 212, in which case the display 604 is exposed. The keypad region 210 of the front cover frame 200 comprises key regions 211 that designate the locations of a multiplicity of user actuatable keys of a keypad installed beneath the keypad region 210. As discussed previously, the keypad can be a standard keypad (lighted or unlighted) rather than a more costly custom keypad, since the tactile experience and feel of the device's keypad are dictated by the characteristics of the material (e.g., TPU) used to fabricate the flexible cover of the front cover frame 200.

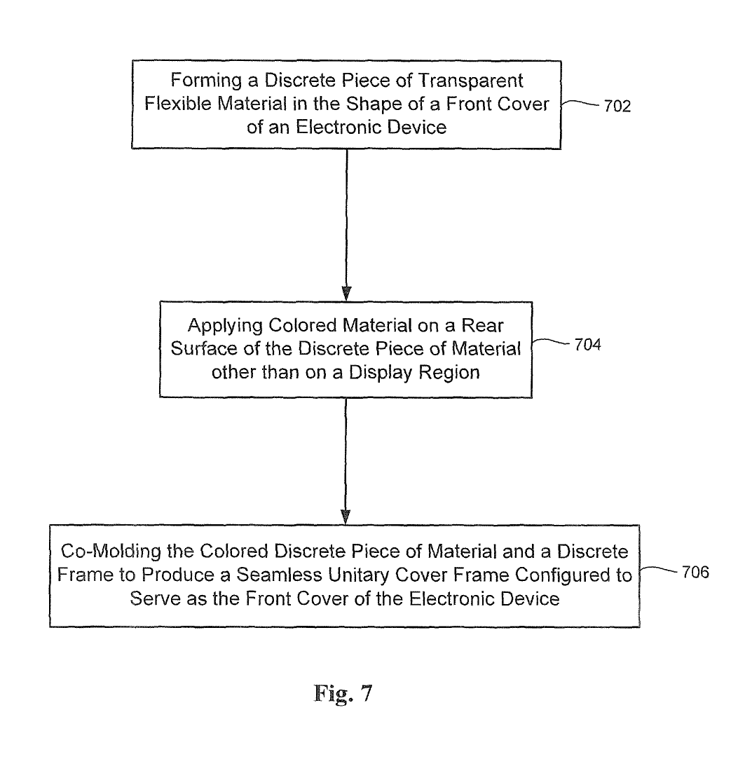

FIG. 7 is a flow chart illustrating a method of constructing a seamless front cover frame configured to serve as a front cover of an electronic device in accordance with example embodiments of the present invention. The example method illustrated in FIG. 7 involves forming 702 a discrete, flat, piece of transparent flexible material to have an outer shape corresponding to a front cover of an electronic device, such as the flexible cover 202 shown in FIGS. 2 and 4. In various example embodiments, the flexible material is a thermoplastic elastomeric material, such as a thermoplastic polyurethane. The example method shown in FIG. 7 also involves applying 704 colored material, such as ink or paint, on the rear surface of the discrete piece of transparent flexible material at various locations other than on a portion of a display region of the discrete piece of material (see, e.g., FIGS. 2 and 4). The example method illustrated in FIG. 7 further involves co-molding 706 the colored discrete piece of material and a discrete frame. This causes the discrete piece of material to conform to the shape of the discrete frame and produces a seamless unitary cover frame configured to serve as the front cover of the electronic device (see, e.g., FIGS. 2 and 3).

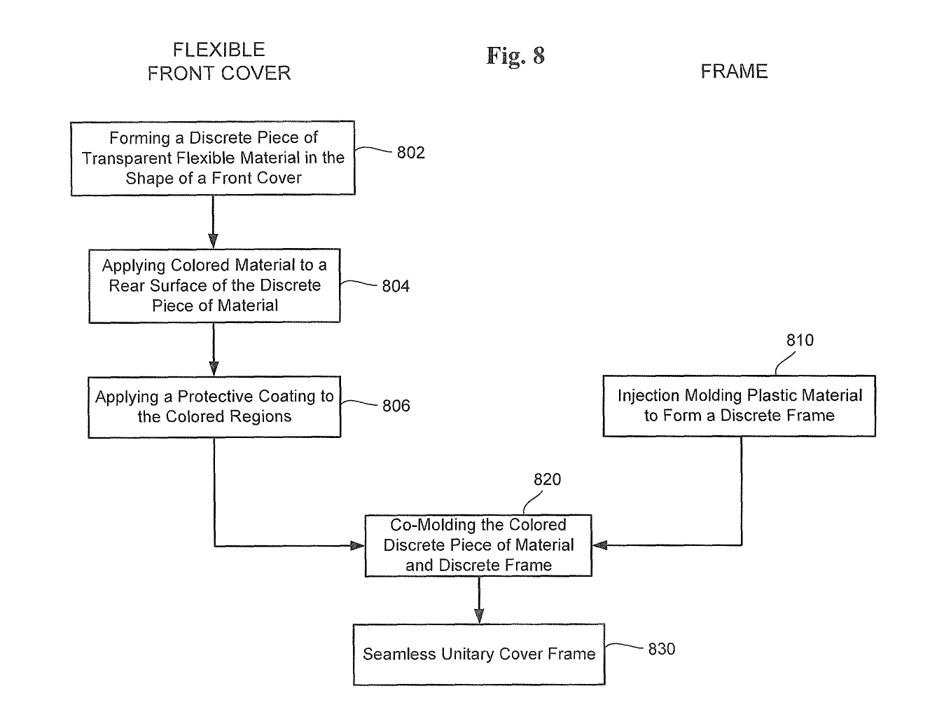

FIG. 8 is a flow chart illustrating a method of constructing a seamless front cover frame configured to serve as a front cover of an electronic device in accordance with other example embodiments of the present invention. The example method illustrated in FIG. 8 involves forming 802 a discrete piece of flat, transparent, flexible material to have an outer shape corresponding to a front cover of an electronic device (see, e.g., FIGS. 2 and 4), and applying 804 colored material on the rear surface of the discrete piece of transparent flexible material at various locations other than on a portion of a display region of the discrete piece of material (see, e.g., FIGS. 2 and 4). A protective coating is applied 806 to at least the colored regions on the rear surface of the front cover frame. The protective coating may include a transparent protective spray, ink, paint, etc that can block ultraviolet rays and keep the flexible material from discoloring. This coating may also prevent underlying colored regions from cracking during high temperatures and pressures experienced during manufacturing. Fabrication of a frame involves injection molding 810 plastic material, such as PC-ABS, to form a discrete frame (see, e.g., FIGS. 3 and 4). The example method illustrated in FIG. 8 further involves co-molding 820 the colored discrete piece of material and the discrete frame. This causes the colored discrete piece of material to conform to the shape of the discrete frame and produces a seamless unitary cover frame 830 configured to serve as the front cover of the electronic device (see, e.g., FIGS. 2 and 3).

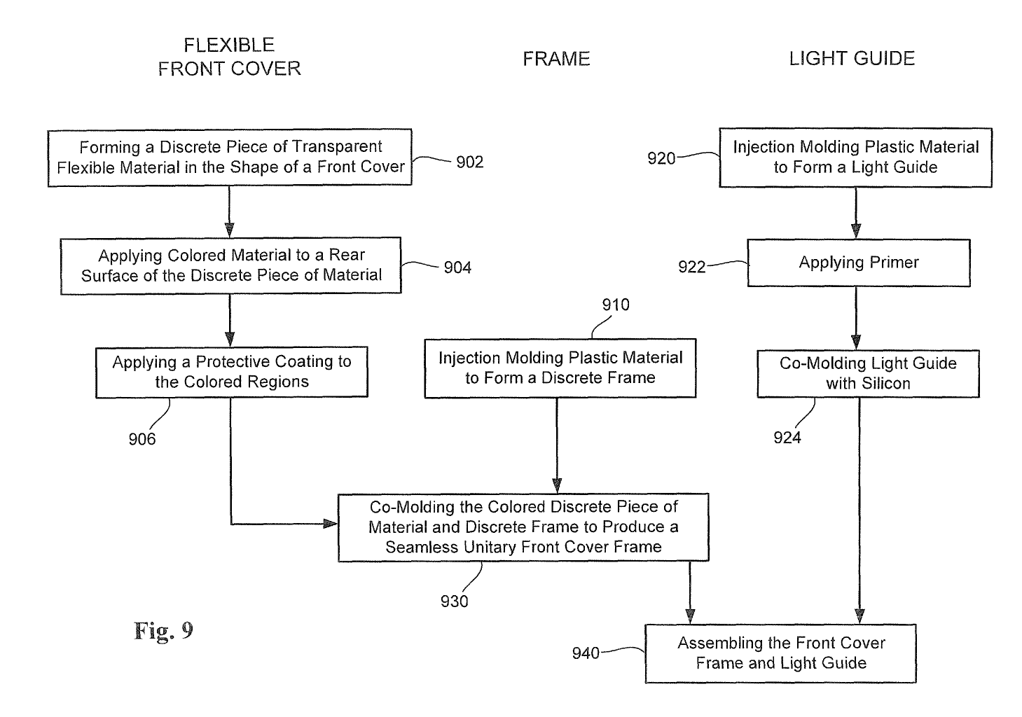

FIG. 9 is a flow chart illustrating a method of constructing a seamless front cover frame configured to serve as a front cover of an electronic device and a light guide in accordance with example embodiments of the present invention. The example method illustrated in FIG. 9 involves forming 902 a discrete piece of flat, transparent, flexible material to have an outer shape of a front cover of an electronic device (see, e.g., FIGS. 2 and 4), and applying 904 colored material on the rear surface of the discrete piece of transparent flexible material at various locations other than on a portion of a display region of the discrete piece of material (see, e.g., FIGS. 2 and 4). According to some example methods, the transparent flexible material comprises TPU, and the colored discrete piece of TPU is heated at about 80° C. for about 120 minutes. A protective coating is applied 906 to at least the colored regions on the rear surface of the discrete piece of transparent flexible material.

Fabrication of a frame involves injection molding 910 plastic material to form a discrete frame. Fabrication of a light guide involves injection molding 920 plastic material to form the light guide, applying primer 922 to the light guide, and co-molding the light guide with silicone to form a silicone keypad (e.g., keys and dome plungers) over the light guide. The example method illustrated in FIG. 9 further involves co-molding 930 the colored discrete piece of transparent flexible material and the discrete frame. This causes the discrete piece of transparent flexible material to conform to the shape of the discrete frame and produces a seamless unitary cover frame configured to serve as the front cover of the electronic device. The example method shown in FIG. 9 also involves assembling the front cover frame and the light guide to produce an assembled apparatus comprising a seamless unitary cover frame with a light guide/keypad affixed to the cover frame with keys situated beneath corresponding key regions of the cover frame. The assembled apparatus is subsequently attached to the front chassis of an electronic device, such as a mobile phone, thereby serving a the front cover of the electronic device.

Various example methods of constructing a seamless front cover frame involve co-molding different materials to form a unitary structures. Example co-molded structures described hereinabove include those discussed with reference to FIGS. 7-9. Fabricating the various structures disclosed herein using co-molding eliminates the need for more complex, time consuming, and expensive molding techniques, such as IML (in-mold-labeling) or FIM (film-insert-molding). IML is understood to involve the use of paper or plastic labels during the manufacturing of an item, such as container, by blow molding, injection molding, or thermoforming processes. The label serves as an integral part of the final product, which results in a pre-decorated item. FIM, also known as in-mold-decorating (IMD), is an advanced method of applying printed graphics to injection molded plastic parts. FIM can be used to apply clear scratch-resistant hard coats, logos, text and graphics in any color or combination of colors to plastic parts prior to injection molding.

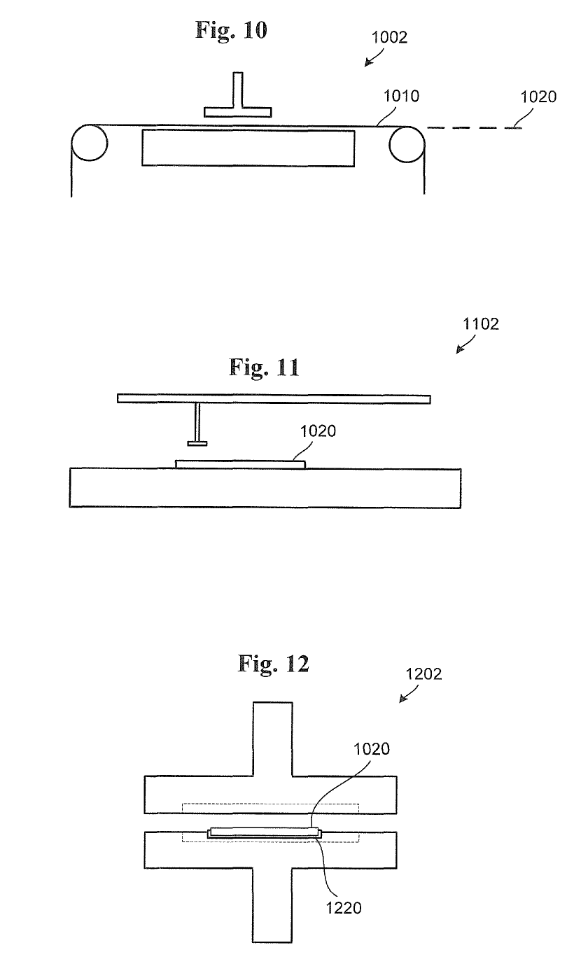

According to other example embodiments of the present invention, and with reference to FIGS. 10-12, an apparatus comprises means 1002 for forming a discrete piece of transparent flexible material 1020 in the shape of a front cover of an electronic device so that the cover is shapeable to comprise a front surface comprising a keypad region and a display region, side surfaces encompassing the periphery of the front surface, and a rear surface. The apparatus also comprises means 1102 for applying colored material at locations on the rear surface of the discrete piece of transparent flexible material 1020 other than on a display portion of the display region. The apparatus further comprises means 1202 for co-molding the colored discrete piece of transparent flexible material 1020 and a discrete frame 1220 to produce a seamless unitary cover frame configured to serve as the front cover of the electronic device.

In the example embodiments illustrated in FIGS. 10-12, an example punch or stamping press 1002 includes a die in the shape of a front cover of an electronic device. A web 1010 of transparent flexible material, such as TPU film, is fed into the press 1002, which uses its die to form a discrete piece of the flexible material 1020. The discrete piece of the flexible material 1020 has a shape that forms a front surface, with extensions of the front surface material defining side surfaces that encompass the front surface when formed around a rigid frame. An example printing station 1102 is illustrated in FIG. 11, with the discrete piece of the flexible material 1020 oriented with its rear surface directed upwardly. An applicator of the printing station 1102 applies colored material to the rear surface of the discrete piece of the flexible material 1020, including on a keyboard region and a display region (other than within a portion of the display region to remain transparent). Appropriate masking is used to create various designs, alphanumeric characters, graphics, and other symbols (negative versions of same) on the rear surface of the discrete piece of the flexible material 1020 so that these designs, graphics, and indicia (positive versions of same) are viewable through the transparent front surface of the discrete piece of the flexible material 1020. In some example embodiments, the printing station 1102 is implemented for screen printing. The screen printing may include a multi-color layered, back printing process similar to silk-screen printing but with high resolution, e.g., 200 dpi. The colored discrete piece of the flexible material 1020 and a frame 1220 formed of rigid plastic (e.g., PC-ABS) are placed in a mold 1202 and co-molded to form a seamless unitary cover frame configured to serve as a front cover of an electronic device.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-20. (canceled)

21. An apparatus, comprising:
a contiguous flexible cover formed from a transparent flexible material and comprising:
a front surface;
side surfaces encompassing the periphery of the front surface; and
a rear surface comprising a keypad region, a display region, and a coating of colored material within the keypad and display regions, the display region comprising a transparent portion; and
a frame integrally attached to the cover to define a seamless unitary cover frame configured to serve as a front cover of an electronic device;
wherein the transparent portion of the display region is configured to align with the display of the electronic device.

22. The apparatus of claim 21, wherein the transparent flexible material comprises a thermoplastic elastomeric material.

23. The apparatus of claim 21, wherein the transparent flexible material comprises a thermoplastic polyurethane.

24. The apparatus of claim 21, wherein:
the transparent flexible material comprises a thermoplastic polyurethane; and
the frame comprises polycarbonate and acrylonitrile butadiene styrene.

25. The apparatus of claim 21, wherein the frame and the cover define a co-molded unitary structure.

26. The apparatus of claim 21, wherein the transparent portion of the display region comprises a UV-protective coating.

27. The apparatus of claim 21, wherein:
the keypad region comprises a plurality of key regions configured to conform to a predetermined keypad layout; and
the colored material within at least the keypad region is disposed around key legends in each of the keypad regions, such that the key legends remain transparent.

28. The apparatus of claim 27, wherein the colored material comprises a plurality of colored materials.

29. The apparatus of claim 21, wherein the apparatus is configured to serve as a front cover of an electronic device.

30. The apparatus of claim 21, wherein the apparatus is configured to serve as a front cover of a mobile phone.

31. An apparatus, comprising:
a contiguous flexible cover formed from a transparent flexible material and comprising a front surface, peripheral side surfaces, and a rear surface comprising a keypad region and a display region, the display region comprising a transparent portion; and
a frame integrally attached to the cover to define a seamless unitary cover frame configured to serve as a front cover of an electronic device;
wherein the transparent portion of the display region is configured to align with the display of the electronic device.

32. The apparatus of claim 31, wherein the transparent portion of the display region is configured to be substantially coextensive with the display of the electronic device.

33. The apparatus of claim 31, wherein the transparent flexible material has a first thickness, and the transparent portion of the display region has a second thickness which is less than the first thickness.

34. The apparatus of claim 31, wherein the transparent flexible material comprises a thermoplastic polyurethane.

35. The apparatus of claim 31, wherein:
the transparent flexible material comprises a thermoplastic polyurethane; and
the frame comprises polycarbonate and acrylonitrile butadiene styrene.

36. The apparatus of claim 31, wherein the frame and the cover define a co-molded unitary structure.

37. An apparatus, comprising:
a contiguous flexible cover formed from transparent thermoplastic polyurethane and comprising:
a front surface;
side surfaces encompassing the periphery of the front surface; and
a rear surface comprising a keypad region, a display region, and a coating of colored material within the keypad and display regions, the display region comprising a void that extends through the front surface; and
a frame integrally attached to the cover to define a seamless unitary cover frame configured to serve as a front cover of an electronic device;
wherein the void of the display region is configured to align and be substantially coextensive with the display of the electronic device.

38. The apparatus of claim 37, wherein the frame and the cover define a co-molded unitary structure.

39. The apparatus of claim 37, wherein the colored material within the keypad region is disposed around key legends in each of the keypad regions such that the key legends remain transparent.

40. An electronic device comprising the apparatus of claim 37 to serve as the front cover of the electronic device.
